(19) United States
(12) Patent Application Publication
(10) Pub. No.: US 2026/0023797 A1
(43) Pub. Date: Jan. 22, 2026

(54) INTELLIGENT SEARCH ENGINE FOR REAL-TIME INFORMATION ACCESS IN CUSTOMIZED LLMS

(71) Applicant: Robert Namin, San Diego, CA (US)

(72) Inventor: Robert Namin, San Diego, CA (US)

(21) Appl. No.: 19/265,925

(22) Filed: Jul. 10, 2025

Related U.S. Application Data
(60) Provisional application No. 63/673,558, filed on Jul. 19, 2024.

(51) Int. Cl. G06F 16/9535; G06F 16/2457; G06F 16/9538

(52) U.S. Cl. CPC G06F 16/9535; G06F 16/24578; G06F 16/9538

(57) ABSTRACT

A method for using contextual searching, such as intelligent search engines, to search for specialized machine learning models, such as customized LLMs (LLMs) tailored to individuals, organizations, and entities, to provide users with access to real-time data, static data, and advanced search capabilities. Therefore, methods and systems are described herein for ensuring precise and efficient information retrieval by identifying relevant artificial intelligence models, such as custom large-language models.

### CROSS-REFERENCE TO RELATED APPLICATION

This application claims priority to, and the benefit of, U.S. provisional patent application Ser. No. 63/673,558 filed on Jul. 19, 2024, incorporated herein by reference in its entirety.

### SUMMARY

Artificial Intelligence (AI) and LLMs (LLMs) have revolutionized various fields, offering significant benefits across multiple critical domains. In medicine, for example, AI-powered diagnostic tools enhance the accuracy and speed of diagnosing diseases, leading to earlier detection and improved patient outcomes. LLMs can analyze vast amounts of medical literature and patient data to identify patterns that may be missed by human practitioners, aiding in the diagnosis of rare conditions or aiding in the generation of personalized treatment plans. In security, AI enhances threat detection and response capabilities through their ability to process and interpret large volumes of data from various sources, identifying potential security threats in real-time and predictive policing models help law enforcement agencies allocate resources more efficiently and prevent crimes.

In order to answer queries from a wide range of end users, many platforms utilize general-purpose LLMs to aid users in everyday tasks. However, while general-purpose LLMs show remarkable capabilities in various tasks, they also present several key issues and limitations compared to specialized LLMs. For example, general-purpose LLMs lack the deep domain-specific knowledge that specialized LLMs possess, making them less reliable for tasks requiring precise and accurate information, such as medical diagnosis or legal analysis. Furthermore, general-purpose LLMs often fail or struggle with tasks that require a nuanced understanding of specific contexts or industries. Where a query includes complex medical data or medical prognoses, for example, a specialized medical LLM trained on extensive healthcare datasets performs much better than a general-purpose LLM.

Specialized LLMs are also less large and resource intensive as general-purpose LLMs. General-purpose AI often requires significant computational power and data to operate effectively. This can make them less practical for certain applications compared to smaller, specialized LLMs that are optimized for specific tasks and can operate more efficiently. However, while specialized models often provide better answers and are less resource intensive, using different custom LLMs can be difficult to integrate. For example, for end users, interacting with multiple custom LLMs and finding the ones that they need each time may be confusing and inefficient. Users may need to learn different interfaces and workflows for each model.

Accordingly, a mechanism is desired that would ensure precise and efficient information retrieval by identifying relevant artificial intelligence models, such as custom large-language models. In particular, a mechanism that allows a user to query a single platform with the capability of identifying custom LLMs that are relevant to the user's query is desired.

One mechanism for doing so comprises using contextual searching, such as intelligent search engines, to search for specialized machine learning models, such as customized LLMs (LLMs) tailored to individuals, organizations, and entities, to provide users with access to real-time data, static data, and advanced search capabilities. Therefore, methods and systems are described herein for ensuring precise and efficient information retrieval by identifying relevant artificial intelligence models, such as custom large-language models.

In one embodiment, a system may enable a user to query using a single platform. The query may be a question or request that is not intended by the user to be directed to any specific LLM. For example, the query may be a query to a single generalized platform, however the system may be enabled to identify specific, relevant LLMs for answering the query. The system can use two intelligent search engines (or a multi-tiered search engine) such as a macro intelligent search engine to broadly identify potentially relevant custom LLMs and a micro intelligent search engine to fine-tune the search and identify the most relevant custom LLM. In some embodiments, there is a one-to-one relationship between each customized LLM and its dedicated micro intelligent search engine. Each LLM may have its own micro search engine to ensure precise and efficient information retrieval tailored specifically to the LLM's domain. Additionally, the system may leverage dynamic machine learning for prompt engineering (also referred to herein as “dynamic prompt engineering”) which, in some embodiments, is a method of real-time prompt refinement using context, interaction history, and feedback to improve intent resolution before model invocation. Accordingly, the system may continuously adapt and optimize prompts based on user interactions, usage trends, and feedback, ensuring more accurate and relevant responses. With such prompt engineering, the present technology can be seen as creating a curriculum engine for each customized LLM that evolves during use without the need for manual fine-tuning.

In some embodiments, the macro intelligent search engine uses one or more algorithms that analyze the user's query to determine the most relevant categories (also referred to herein as “groups”). The algorithm(s) may consider factors like context, keywords, and user preferences to prioritize categories. Detailed steps of the algorithm include natural language processing (NLP), contextual analysis, and machine learning models trained on large datasets to enhance accuracy. Dynamic machine learning for prompt engineering further refines the queries by dynamically adjusting the prompts based on real-time user inputs and interactions.

Doing so may help to consolidate information from disparate sources into a single interface, streamlining user experience and improving accessibility. Further, such a system can provide a consistent interface design that reduces confusion and facilitates user adoption, while also promoting documentation and sharing of successful issue resolutions. Unified access to internal and external sources may enhance information accessibility, enabling organizations to document and share successful resolutions to compliance issues and other challenges, fostering a culture of continuous improvement and knowledge sharing.

Various other aspects, features, and advantages of the invention will be apparent through the detailed description of the invention and the drawings attached hereto. It is also to be understood that both the foregoing general description and the following detailed description are embodiments and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative system for managing customized models, such as adding customized models or identifying customized models that are relevant to a user's query, in accordance with one or more embodiments of this disclosure.

FIG. 1B shows an exemplary macro intelligent search engine, in accordance with one or more embodiments of this disclosure.

FIG. 2 illustrates an exemplary user interface from which an end user may access and query multiple customized models, e.g., such as through a chatbot, in accordance with one or more embodiments of this disclosure.

FIG. 3A illustrates an exemplary database storing customized models, e.g., custom LLMs, in accordance with one or more embodiments of this disclosure.

FIG. 3B illustrates an exemplary database storing customized models, in accordance with one or more embodiments of this disclosure.

FIG. 4 illustrates an exemplary machine learning model, in accordance with one or more embodiments of this disclosure.

FIG. 5 illustrates a flowchart of a method that can be performed to manage customized models, in accordance with one or more embodiments of this disclosure.

FIG. 6 illustrates a computing device that can be used for synthetic data generation, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

As described herein, in order to answer queries from a wide range of end users, general-purpose LLMs are typically used. While such general-purpose LLMs present several key issues including a lack of deep domain-specific knowledge and a high computational and resource cost, many platforms choose to use a single general-purpose model for ease of convenience and also to conserve on efficiency that is needed to switch back and forth, or search from many different customized models.

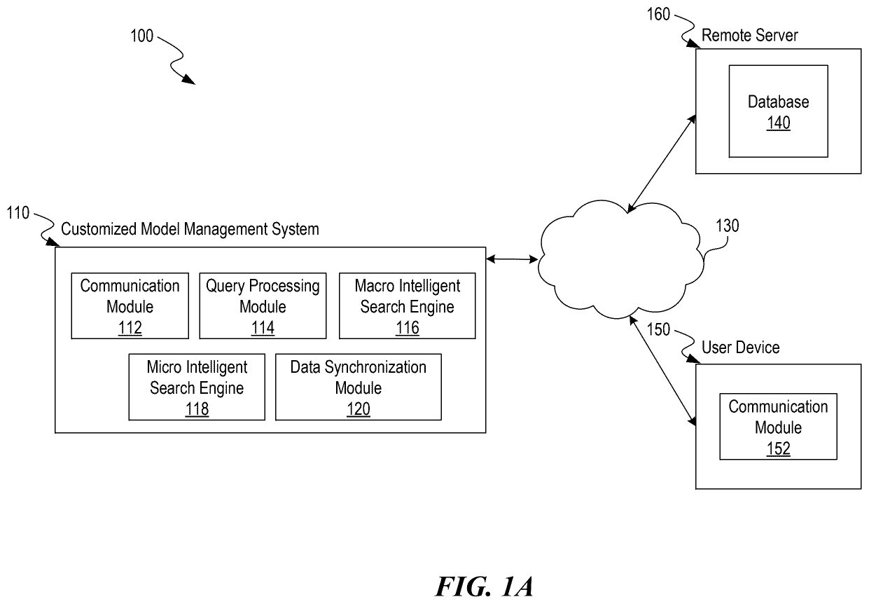

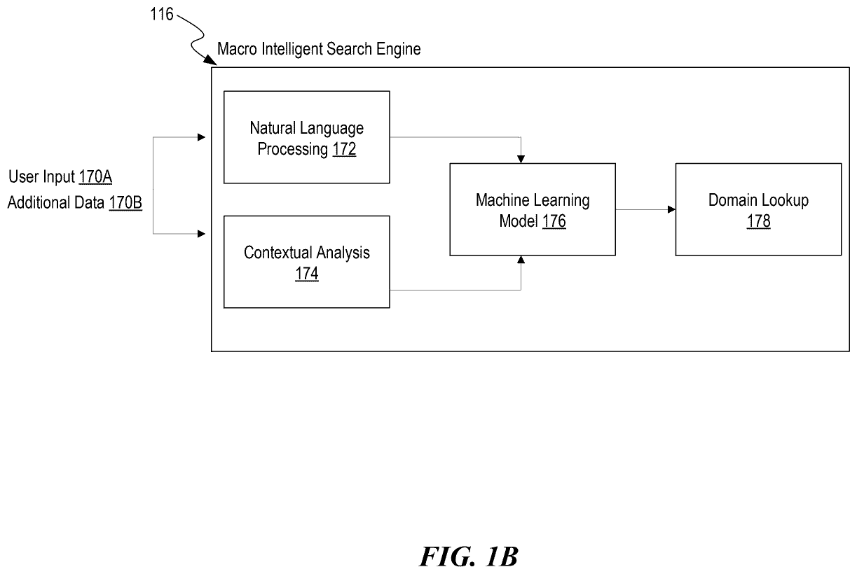

Thus, an environment that is able to efficiently identify relevant customized models based on user queries is needed. Doing so may significantly enhance user experience and foster efficient problem-solving practices within organizations. Further, doing so may enable a cohesive experience for users, allowing users to seamlessly transition between a company/organization-specific search engine and the macro-scale search engine. Environment 100 of FIG. 1A is an example system for efficiently managing customized models, such as adding customized models or identifying customized models that are relevant to a user's query, in accordance with one or more embodiments of this disclosure.

Environment 100 includes customized model management system 110, user device 150, and remote server 160. In some embodiments, customized model management system 110 executes instructions for adding in new customized models, or for identifying and using customized LLMs that are relevant to a user's query, e.g., on the user device 150. In such embodiments, customized model management system 110 includes software, hardware, or a combination of the two. For example, customized model management system 110 may be a physical server or a virtual server that is running on a physical computer system. In some embodiments, customized model management system 110 is configured on a user device (e.g., a laptop computer, a smartphone, a desktop computer, an electronic tablet, or another suitable user device).

In some embodiments, the customized model management system 110 is used by users to retrieve relevant answers to a user's query by identifying relevant customized models (e.g., custom LLMs) and providing the answer to the user at user device 150. The user device 150 of these embodiments comprises, for example, a cell phone, a smart watch, a computer, a wearable device, and/or similar devices. The user device 150 enables one or more methods for inputting queries. For example, the user device 150 may include microphone or camera sensor modules that enable inputs such as through voice command, gestures (e.g., sign language), QR code scanning, etc. Alternatively or additionally, in some embodiments, the user device 150 includes different input terminals, such as a touch screen, keyboard, or mouse, through which an end user inputs queries, such as to input a query into a chatbot application, on a browser, through text, etc.

As described herein, users input their queries or requests using natural language, voice commands, or text messages, specifying the information they need or the tasks they want to accomplish. Additionally, according to some embodiments, the users specify or add in attachments such as images, audio clips, patient records, financial records, etc. For example, the user may include identifiers for the attachments that the customized model management system 110 can access from remote databases via network 130 and communication module 112.

Further, in other embodiments, the users scan a QR code as an input representing their query or request. For example, a scanned QR code may include a pre-generated search query or may cause the customized model management system 110 to automatically identify a specific custom LLM to use in responding the a user's query or request. As a yet further example, a scanned QR code can be associated with a specific entity, product, location, or domain, and deterministically route the user to an appropriate customized LLM without requiring the intent classification or metadata matching of the present technology. Such direct routing enables low-latency interactions with specialized knowledge domains like the customized LLMs. In some embodiments, QR codes linked to a particular LLM domain include authentication protocols to verify ownership. For example, upon scanning the QR code, the present technology can verify the associated particular LLM's metadata, ownership credentials, and digital fingerprint (described further below) before initiating the user interaction. This is expected to ensure secure, auditable access to the correct entity-specific model.

In another embodiment, a QR code links to a locally hosted or edge-deployed customized LLM embedded in a device, such as a mobile device, kiosk, or Nvidia Jetson edge unit. This enables real-time interaction even in offline or low-connectivity environments. For example, a field technician in a rural area can scan a QR code on a sample kit, triggering an offline LLM hosted on their edge device for diagnosis. In some embodiments, the embedded LLM is pre-trained and updated asynchronously when connectivity is restored. Further, when QR codes are used to trigger interactions with offline or edge-hosted LLMs, the present technology includes functionality to log user interactions, queries, and fulfillment outcomes at the edge-hosted LLM or edge device. This metadata is then synced back to a cloud-based datastore of the present technology upon restoration of network connectivity and is used to retrain the macro intelligent search engine 118 described below, update digital fingerprints described below, or flag unresolved queries for SME review.

In some embodiments, the user device 150 performs some parsing or speech-to-text conversion prior to transmitting the query to the customized model management system 110 via communication module 152 and network 130. According to some embodiments, the user device is configured to preprocess the input into a suitable query. For example, if the query is input via voice, camera, and/or the like, the user device 150 may include modules that are able to convert speech to text (e.g., using automatic speech recognition (ASR) models) or identify gestures. In other embodiments, the user device 150 transmits either the raw input of the queries or the preprocessed (e.g., parsed) input of the query via communication module 152 and network 130 to the customized model management system 110. In some embodiments, communication module 152 is configured to perform similarly or equivalently to communication module 112 described herein.

In some embodiments, the user device 150 includes sensor modules, or modules such as integrated GPS, to pass on relevant information as part of the query to customized model management system 110 to identify the relevant custom models to use. Additionally, in other embodiments, the user device 150 or customized model management system 110 extracts metadata from the query to identify the relevant custom models to use. For example, upon scanning a QR code with user device 150, the user device 150 can transmit the query along with location metadata corresponding to where the QR code was scanned by user device 150 to the customized model management system 110. In another example, when a user enters a natural language text query into the user device 150, transmit the query along with timestamp and device information metadata to the customized model management system 110.

In some embodiments, the customized model management system 110 receives the query (e.g., raw input or preprocessed query) via communication module 112 and network 130. In some embodiments, network 130 is a local area network (LAN), a wide area network (WAN; e.g., the internet), or a combination of the two. In other embodiments, communication module 112 includes software components, hardware components, or a combination of both. For example, communication module 112 may include a network card (e.g., a wireless network card and/or a wired network card) that is associated with software to drive the card. In some embodiments, communication module 112 may pass at least a portion of the data of the query, or a pointer to the data in memory, to other subsystems such as query processing module 114, macro intelligent search engine 116, micro intelligent search engine 118, and data synchronization module 120.

In some embodiments, the query includes attachments such as images and customized model management system 110 performs image recognition and includes the result of the image recognition with the query for further processing. This capability is expected to enable accurate and immediate identification of various entities, enhancing the user experience. According to some embodiments, as described herein, the user device 150 or customized model management system 110 also include additional details with the query, such as GPS coordinates from a GPS module, and/or the like.

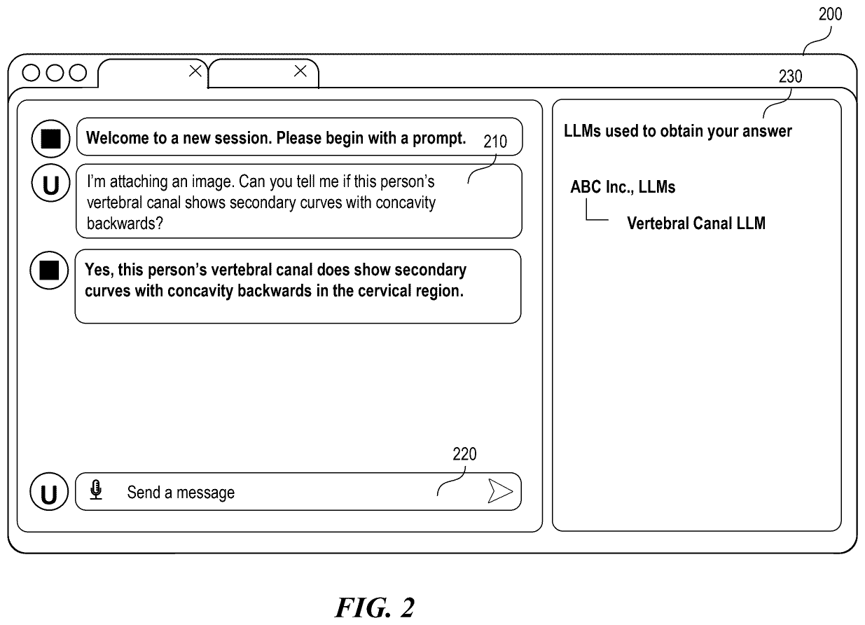

In some embodiments, once the user inputs the query, such as query 210 of FIG. 2 below, the customized model management system 110 uses intelligent search engines (or a single tiered search engine) to determine which of the customized models are most relevant and best suited for answering the question.

For example, once the customized model management system 110 receives the query via communication module 112, the communication module 112 may pass at least a portion of the query data, or a pointer to the data in memory, to query processing module 114. In some embodiments, the query processing module 114 processes the query if needed (e.g., ASR, speech-to-text, image processing, gesture recognition, bag-of-words (BoW) etc.). For example, in the case where the user device 150 performed little to no preprocessing, the query processing module 114 may perform the preprocessing described herein in relation with the user device 150.

In some cases where preprocessing is not needed, the communication module 112 passes at least a portion of the query data, or a pointer to the data in memory, to macro intelligent search engine 116. Alternatively, in other embodiments, the query processing module 114 passes at least a portion of the processed query data, or a pointer to the data in memory, to macro intelligent search engine 116. In some embodiments, macro intelligent search engine 116 is a first tier (or first stage) of a general search engine of customized model management system 110. In some embodiments, the macro intelligent search engine 116 uses AI and machine learning algorithms to analyze the intent of the user in their query and considers contextual behaviors and information to identify a relevant customized model. For example, the macro intelligent search engine 116 may use semantic search, personalized recommendations, and/or the like to predict the user's intent and identify contextual clues to use in determining relevant customized models. In some embodiments, if the present technology determines that a user's intent was not achieved during their search (e.g., after processing with the macro intelligent search engine 116 and micro intelligent search engine 118), the user's query is forwarded to a human operator to refine the query to achieve the user's intent. Then, with the refined query, the system repeats the process, passing the refined query to the macro intelligent search engine 116 to determine the group of customized models.

According to some embodiments, the macro intelligent search engine 116 is used to identify whether the query or request is best answered or performed by groups (also referred to herein as “categories”) of models (e.g., LLMs) related to specific entities, individuals, or organizations. Once the macro intelligent search engine 116 identifies the group, it passes data identifying the group, or a pointer to the data in memory, to micro intelligent search engine 118. In some embodiments, micro intelligent search engine 118 then identifies specific customized models that are most relevant to the query. In some embodiments, micro intelligent search engine 118 is a second tier (or second stage) of a general search engine of customized model management system 110.

In some embodiments, the macro intelligent search engine 116 determines that a user's input query or request, the corresponding metadata, or a combination of the two are too vague or imprecise to identify the group of models that can best answer the query or request. In such embodiments, the customized model management system 110 will ask the user one or more follow up questions via the user device 150 to obtain more information to identify which groups of models can best answer or perform the user's query or request. In other embodiments, the micro intelligent search engine 118 determines that a user's input query or request, the corresponding metadata, or a combination of the two are too vague or imprecise to identify the specific customized models that are most relevant to the query. In such embodiments, the customized model management system 110 will ask the user one or more follow up questions via the user device 150 to obtain more information to identify the specific customized models that are most relevant to the query. In some embodiments, asking the user a follow up question is part of the dynamic prompt engineering process.

Subroutines and algorithms within the macro and micro intelligent search engines guide each of the macro intelligent search engine 116 and micro intelligent search engine 118 in retrieving data from both real-time and static sources based on user inputs. In some embodiments, the subroutines and algorithms guide the retrieval of data from both real-time and static sources. Machine learning algorithms and natural language processing (NLP) techniques are used to analyze and interpret the retrieved information. In some embodiments, the macro and micro intelligent search engines include components such as Natural Language Processing (NLP) for understanding and processing user queries, contextual analysis to determine the relevance of the query, one or more machine learning models for predictive analytics and improving search accuracy, dynamic prompt engineering to enable machine learning models to dynamically adjust and optimize prompts to enhance the relevance and accuracy of responses based on ongoing user interactions, real-time data fetching including subroutines that access APIs and data streams for up-to-date information, and static data retrieval which may include algorithms that search databases and indexed data sources.

According to some embodiments, the intelligent search engines use data specific to each customized model to identify the model that is most relevant to the user's query. For example, during development and integration of the model into the platform or system, customized model management system 110 may ask a series of targeted questions that provide context on how or when the customized model should be used. As another example, when creating a customized LLM, such as a real estate LLM for a real estate company, the LLM developer may be asked questions like the street address, state, and zip code of properties owned by the real estate company. This information allows the intelligent search engine to precisely match user queries (e.g., “houses for sale near me”) to specific locations using a combination of GPS data and/or spoken input. Similarly, for LLMs developed by a subject matter expert (e.g., a doctor specializing in a certain form of medicine), a structured series of questions may be used to capture and enter relevant information about the subject matter into a data file associated with the subject matter expert's LLM. This data associated with the subject matter expert's LLM can later be used to aid the intelligent search engines in identifying the subject matter expert's LLM when a user inputs a query related to that subject matter.

Further, in some embodiments, metadata is collected by the intelligent search engines during the creation and set up of each customized model. The metadata includes information such as an industry, a language, access rules, a modality, a GPS location, and other metadata associated with the customized model. In some embodiments, the collected metadata becomes a digital fingerprint of the customized model. The digital fingerprint is a machine-readable identifier that includes both static tags and dynamic metadata updates. Accordingly, in some embodiments, the macro intelligent search engine 116 uses the digital fingerprint to route user queries to the relevant customized model(s). In other embodiments, the digital fingerprint of customized models are indexed within the macro intelligent search engine 116.

According to some embodiments, the macro intelligent search engine 116 identifies whether the query or request can best be answered or performed by groups of models (e.g., LLMs) related to specific entities, individuals, or organizations and determines which of those groups of models can answer or perform the query or request in the most energy efficient manner (e.g., the lowest power or smallest model). For example, in the case that the macro intelligent search engine 116 determines that a query can be handled by a group of general models or a group of small specialized models, the macro intelligent search engine 116 can select the group of small specialized models to answer the query, limiting the energy required to answer the user's query.

In some embodiments, the micro intelligent search engine 118 identifies specific customized models that are most relevant to a user's query or request and determines the which of those specific customized models is the most energy efficient (e.g., the lowest power or smallest model). For example, in the case that the micro intelligent search engine 118 determines that a query can be handled by two specialized models, the micro intelligent search engine 118 can select the smallest of the two models to answer the query, limiting the energy required to answer the user's query.

According to some embodiments, the macro intelligent search engine 116 identifies whether the query or request can best be answered or performed by groups of models (e.g., LLMs) related to specific entities, individuals, or organizations and prioritizes the groups of models that comprises premises models as opposed to cloud-based models. For example, in the case that the macro intelligent search engine 116 determines that a query can be handled by a group of one or more premises models and by a group of one or more cloud-based models, the macro intelligent search engine 116 can select the group of one or more premises models to answer the query. Generally, prioritizing premises models over cloud-based models reduces the energy required to answer or perform a user query or request.

In some embodiments, the micro intelligent search engine 118 identifies specific customized models that are most relevant to a user's query or request and prioritizes the groups of models that comprises premises models as opposed to cloud-based models. For example, in the case that the micro intelligent search engine 118 determines that a query can be handled by a specialized premises model and a specialized cloud-based model, the micro intelligent search engine 118 can select the specialized premises model to answer the query.

In some embodiments, the customized models are stored and run on the customized model management system 110. However, according to some embodiments, one or more of the customized models are be stored and executed on a remote server, as shown in FIG. 1A. For example, the remote server 160 may include database 140, storing groups of customized models.

As described herein, the customized model management system 110 includes data synchronization module 120 that includes robust synchronization mechanisms to ensure that information remains up-to-date and consistent across both search engines, maintaining data integrity and reliability. For example, data synchronization may occur between real-time data sources (e.g., such as live APIs) and static data repositories (e.g., such as databases). This is expected to ensure that the information retrieved by the LLMs is current and consistent across different sources. Dynamic machine learning models are also expected to help optimize this synchronization process by ensuring that the most relevant and up-to-date information is prioritized. Additionally, in some embodiments, synchronization logs, including deferred synchronization logs, are retained by the customized model management system 110 and use as training data for the customized models.

According to some embodiments, the customized model management system 110 also includes one or more additional modules that support user interaction and backend processes. Each of these additional modules include one or more algorithms to ensure that data fetched in real-time and from static sources are integrated and synchronized efficiently. For example, they may generate access requests for real-time data or static data from remote servers. Sources may include APIs, databases, and data warehouses. In some embodiments, the dynamic machine learning for prompt engineering is used in these modules to refine and improve the processing of user queries.

As described herein, the customized model management system 110 provides contextually relevant responses to the user's queries, such as insights, recommendations, or actionable information to address the user's needs. In some embodiments, the response is provided via communication module 112 and network 130 to the user device. The user interacts with the provided responses, reviewing the information presented, asking follow-up questions, or taking necessary actions based on the system's recommendations. In some embodiments, the customized model management system 110 enables users to engage with the customized model management system 110 continuously, refining their queries, exploring additional information, or performing subsequent tasks as needed to achieve their objectives. In other embodiments, users also provide feedback on the system's responses and functionalities, which is used to improve and refine the customized model management system 110 over time through iterative updates and enhancements. In yet further embodiments, the customized model management system 110 continuously adapts and learns from user interactions and feedback, refining its algorithms and decision-making processes over time. Accordingly, the present technology can be seen as creating a curriculum engine that evolves without the need for manual fine-tuning.

FIG. 1B shows an exemplary macro intelligent search engine 116, in accordance with one or more embodiments of this disclosure. For example, the user's input 170A and additional data 170B (e.g., GPS or other metadata) can be input or otherwise passed or accessed by the macro intelligent search engine 116. For example, a user may be driving down the road and see a house for sale, a coffee shop, or a billboard sign. The user may use their cell phone to either speak a query like “I see this house for sale” or “What's this coffee shop?” and provide the location or take a picture of the entity. In some embodiments, additional data (e.g., metadata) is acquired by the customized model management system 110. For example, the system may use GPS to pinpoint the exact location and obtain GPS coordinates that identify the location of the entity.

In some embodiments, each of the inputs (e.g., user inputs, additional data) is be passed to one or both of natural language processing (NLP) 172 and contextual analysis 174. During NLP, the customized model management system 110 parses the user's spoken query or image data to understand the intent and extract key entities, individuals, and organizations. In some embodiments, the output includes a refined query or data set to be used by the search engine. According to some embodiments, Contextual Analysis 174 includes analyzing the parsed query within the relevant context, whether it's real estate, hospitality, education, etc. In some embodiments, the output of contextual analysis includes a refined query that incorporates contextual understanding.

In the embodiments, the refined queries are input into one or more machine learning models such as machine learning model 176. The machine learning models utilize trained models on large datasets to match the refined query with the most relevant listings or information. The output of the machine learning model includes a list of relevant results, ranked by relevance to the refined query. The relevant results are then be used to perform a domain lookup 178, where the customized model management system 110 checks if there is a registered domain for the address ending in .LLM. In some embodiments, the result of the domain lookup includes an identification of the specific domain, e.g., “123MainSt.LLM” for a house, or “BlueCoffee.LLM” for a coffee shop.

As described herein, the macro intelligent search engine 116 is enabled to perform dynamic machine learning for prompt engineering (also referred to herein as “dynamic prompt engineering”) by continuously refining the search results by dynamically adjusting the prompts based on real-time user inputs and interactions and previous usage trends. Doing so is expected to enable search results that improve in accuracy and relevance as the user interacts with the customized model management system 110. The macro search engine identifies a plurality of potentially relevant LLMs based on the user's query. The micro search engine then fine-tunes this selection to identify and access the most relevant LLM for providing the precise answer or action required.

According to some embodiments, the macro intelligent search engine 116 identifies a relevant domain and directs the customized model management system 110 to the relevant domain (e.g., “realestatecompany.LLM,” “BlueCoffee.LLM,” or “MainSchool.LLM”). For example, the macro intelligent search engine 116 may provide access to the specific micro intelligent search engine 118 for detailed information. The user may follow-up with requests for specific information, such as “Show me a picture of the kitchen” for a house or “What's the menu?” for a coffee shop. The micro intelligent search engine 118 may then retrieve the requested information from the relevant domain.

In some embodiments, if an LLM and/or a custom URL designation for an LLM cannot be found and/or has not been established yet, e.g., no custom LLM is sufficiently related to the user's query and other information provided by the user's device (e.g., GPS), a custom LLM is created and a URL designation (e.g., .LLM domain) may be registered for the entity/organization/individual. For example, the customized model management system 110 may collect data and may also send a notification (e.g., text or email) to alert the relevant business or individual of the creation of the domain and LLM.

According to some embodiments, the customized model management system 110 is used, e.g., such as part of a social media network, to generate LLMs specific to users as part of user profile creation. For example, the customized model management system 110 may ask users to fill out a profile with information such as their name, interests, preferences, and verification details and generate a verified and authenticated .LLM domain for the user, e.g., “JohnDoe.LLM.”

In another example, the customized model management system 110 is used to provide personalized assistance. The search engine may use the customized LLM to provide highly relevant information tailored to the user's profile. For example, a college student at the University of Oregon can input their academic details (e.g., “Economics 201”) and hobbies (e.g., golf), and the customized model management system 110 searches all available LLMs to offer relevant assistance, such as study materials or local golf exercises.

In another example, the customized model management system 110 is used to provide contextual recommendations. For example, if the user mentions liking pizza, the customized model management system 110 can suggest a local pizza place with the domain “Pizzaplace.LLM.” If the user wants to share a photo, the customized model management system 110 can assist with posting on social media like Facebook or Instagram. The customized model management system 110 may be used to provide tailored recommendations that enhance the user's experience based on their personalized LLM.

In another example, the customized model management system 110 is used to provide controlled information sources such that users can control their information sources, choosing to receive updates and content from trusted or verified LLMs, thereby reducing exposure to junk mail or fake news. By doing so, the customized model management system 110 may enable the user to have a more curated and reliable flow of information.

As described herein, a user may provide the query in various different channels such as a web portal, mobile application, or integrated chatbot interface. FIG. 2 illustrates an exemplary user interface from which an end user may access and query multiple customized models, e.g., such as through a chatbot, in accordance with one or more embodiments of this disclosure. In some embodiments, the user interface 200 is accessed by the user via user device 150. For example, the user may access the user interface 200 via an application or through a browser.

In some embodiments, the user interface 200 includes an input terminal 220, through which a user can provide their query in text. The user may also select the record icon to record a query via speech, and a speech-to-text algorithm or ASR model may be applied to convert the spoken query into text. In some embodiments, the query includes attachments such as images and customized model management system 110 performs image recognition and includes the result of the image recognition with the query for further processing. This capability is expected to enable accurate and immediate identification of various entities, enhancing the user experience. According to some embodiments, as described herein, the user device/customized model management system 110 also includes additional details with the query, such as GPS coordinates from a GPS module, and/or the like.

In some embodiments, once the user inputs the query, such as query 210, the customized model management system 110 uses intelligent search engines to determine which of the customized models are most relevant and suited for answering the question. In some embodiments, upon identifying a particular customized model most suited for answering the question, the customized model management system 110 automatically transmits the query to the particular customized model and presents a response from the particular customized model in user interface 200. In some embodiments, the user interface 200 also indicates via window 230 the specific customized models used in answering the user's query. For example, in the example of FIG. 2, the user queried “I'm attaching an image. Can you tell me if this person's vertebral canal shows secondary curves with concavity backwards?” Based on the information in the query, the customized model management system 110 may identify the specific types of LLMs needed and display to the user that the group of models from which the customized model was selected was “ABC Inc., LLMs,” and that the customized model was “Vertebral Canal LLM.”

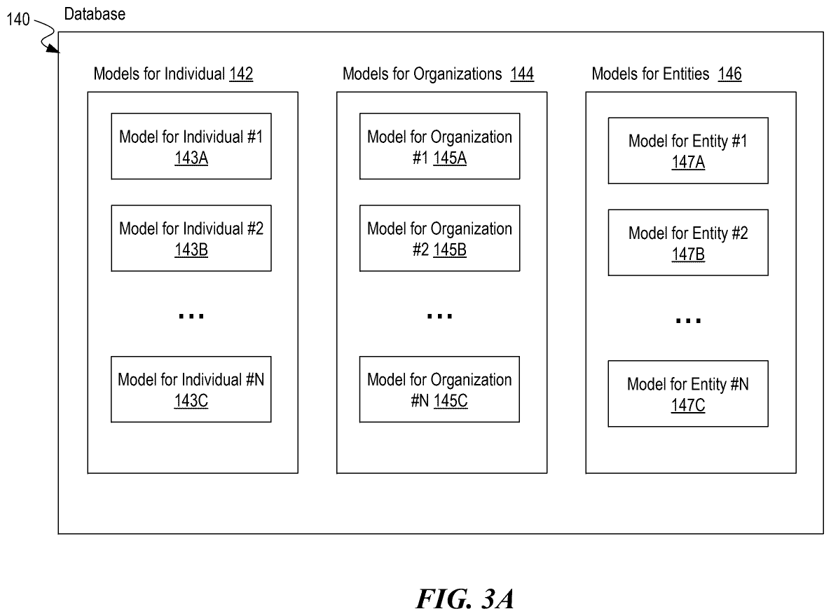

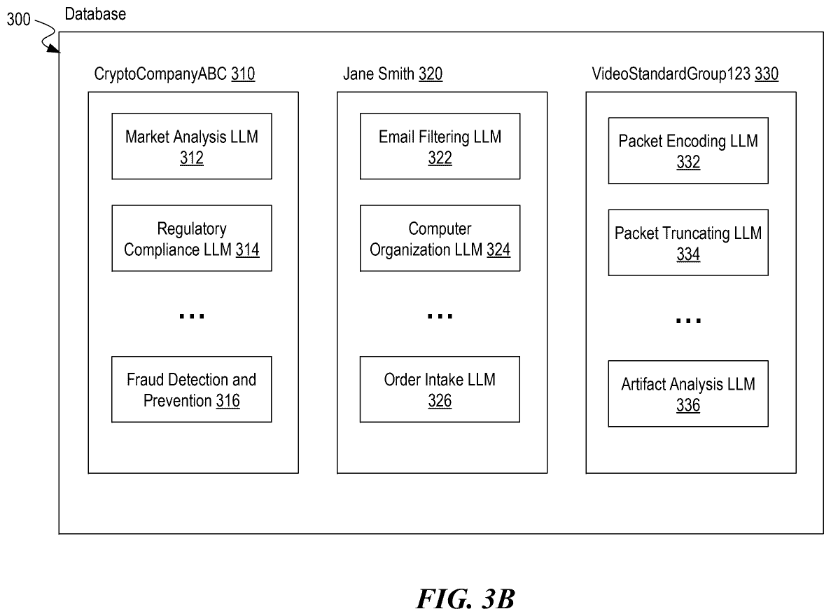

FIG. 3A illustrates an exemplary database storing customized models, e.g., custom LLMs, in accordance with one or more embodiments of this disclosure. For example, the database 140 may store models for individuals 142, models for organizations 144, and models for entities 146.

Each of the groups may include specific custom models, such as model for individual #1 143A, model for individual #2 143B, model for individual #N 143C, model for organization #1 145A, model for organization #2 145B, model for organization #N 145C, model for entity #1 147A, model for entity #2 147B, and model for entity #N 147C. Further, in some embodiments, the models are indexed in database 140 by a category, metadata, or both. For example, the models may be indexed by the individual, organization, and entity categories described above, as well as indexed within each category based on metadata associated with each model (e.g., model creator, model creation date, tags, keywords, etc.).

In some embodiments, indexing the models in database 140 comprises establishing categorical function indicia allowing the search engines of customized model management system 110 to identify the relevant groups of models and specific customized models that are most relevant to the query. In some embodiments, the categorical function indicia allow the search engines of customized model management system 110 to identify the relevant groups of models and specific customized models similar to search engines that find existing websites. For example, with data extracted from the customized models, the models can be categorized by function indicia in database 140 and when a user inputs a query to the user device 150, the customized model management system 110 can match the query to the indexed customized models, rank the results based on factors like relevance, and then select the most relevant customized model to complete the query. For example, FIG. 3B is an exemplary database illustrating how categories (also referred to herein as “groups”) of models may be stored or accessed and how entity-specific, organization-specific, and individual-specific custom models. For example, database 300 may have categories specific to entities, organizations, and individuals such as “CryptoCompanyABC” 310, “Jane Smith” 320, and “VideoStandardGroup123” 330. The “CryptoCompanyABC” 310 may have specific models that are developed or used specifically by members related to or having access to (e.g., security tokens, keys, etc.) the content of “CryptoCompanyABC” 310. For example, the category “CryptoCompanyABC” 310 includes market analysis LLM 312, regulatory compliance LLM 314, and fraud detection and prevention LLM 316. Similarly, the category for individual “Jane Smith” 320 may include LLMs such as email filtering LLM 322, computer organization LLM 324, order intake LLM 326. The category for entity “VideoStandardGroup123” 330 may include LLMs such as packet encoding LLM 332, packet decoding LLM 334, and artifact analysis 336.

In some cases, when users develop and store each of the LLMs for usage as part of the platform, the users may include information that may be used to direct relevant queries to the LLM. For example, in the case where the LLM is an LLM specific to a real estate property available for purchase, and the developer is a real estate agent who has developed the LLM to answer questions regarding the cost, number of bedrooms or bathrooms, square footage, etc. the developer may include information such as location to help direct the platform to identify the LLM. In one example, the user may include informative tags or parameters such as GPS location, town name, state, country, etc. The categorization helps in organizing and searching within specific domains, making the search process more efficient.

Although not shown in the example of FIG. 3B, different categories of models may share custom models. Similarly, for some entities, organizations, and/or individuals, subcategories for models may exist under each category as well.

In some embodiments, each customized model (e.g., customized LLM) are associated with a specific domain, providing a distinct identity and specialized functionality for various entities. For example, where the customized model is a customized LLM, the LLM may be associated with a specific .LLM domain. This structure allows for highly specific and localized searches, directly linking user queries to the most relevant LLM, whether it is for a property, a coffee shop, a billboard sign, a school, or any other point of interest. In some embodiments, the customized model has a custom URL designation, e.g., a custom URL designation for a domain-specific LLM. This may include a unique web address assigned to the model or its associated service. The unique web address may be established or generated to be unique from others, and may include the name of the entity, individual, organization, project, or specific application. In some embodiments, the web address may include one or more repositories, access points, or APIs.

In some embodiments, the customized models stored in the database 140 are indexed such that the models are indexed by their individual .LLM domain. For example, customized models stored in database 140 may include their specific .LLM domain along with data related to the customized models' subject matter, their relationship to an entity, organization, or individual, their access points or APIs, etc. In some embodiments, the individual .LLM domains can represent categorical function indicia.

In some embodiments, the system uses algorithms to analyze user input (text, images, videos) and match it to a specific URL within the customized LLM. This URL designation indicates a unique LLM tailored to the query context, ensuring precise and relevant responses. In some embodiments, these algorithms include NLP (Natural Language Processing) and contextual analysis algorithms. These algorithms are designed to understand the user's query and context, ensuring that the most relevant customized LLM is identified and utilized. Additionally, machine learning models trained on large datasets are used to enhance the accuracy of matching user input to the specific LLM URL.

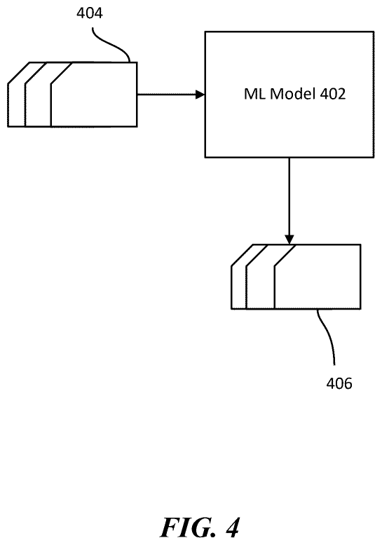

FIG. 4 illustrates an exemplary machine learning model 402 (e.g., the first and/or second machine learning model) that may be used as part of the intelligent search engines or as part of the query parsing and/or custom AI models. According to some embodiments, the machine learning model is any model, such as a model for classification. For example, the machine learning model may be trained to intake input 404 including input data and receive, as a result of processing the input 404 via the machine learning model, an output 406. The machine learning model may have been trained on a training dataset containing different parameters of user data samples or profiles and corresponding value of a parameter acting as a target value. An exemplary machine learning model is described in relation to FIG. 4 herein.

In some embodiments, the output parameters are fed back to the machine learning model as input to train the machine learning model (e.g., alone or in conjunction with user indications of the accuracy of outputs, labels associated with the inputs, or other reference feedback information). In some embodiments, the machine learning model updates its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback.

In some embodiments, one or more neurons of the neural network require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function that combines the values of all of its inputs together. Each connection (or the neural unit itself) may have a threshold function that a signal must surpass before it propagates to other neural units. The machine learning model may be self-learning and/or trained rather than explicitly programmed and may perform significantly better in certain areas of problem solving as compared to computer programs that do not use machine learning. During training, an output layer of the machine learning model may correspond to a classification of the machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector. The machine learning model may be structured as a factorization machine model. The machine learning model may be a non-linear model and/or supervised learning model that can perform classification and/or regression. For example, the machine learning model may be a general-purpose supervised learning algorithm that the customized model management system 110 uses for both classification and regression tasks. Alternatively, the machine learning model may include a Bayesian model configured to perform variational inference on the graph and/or vector.

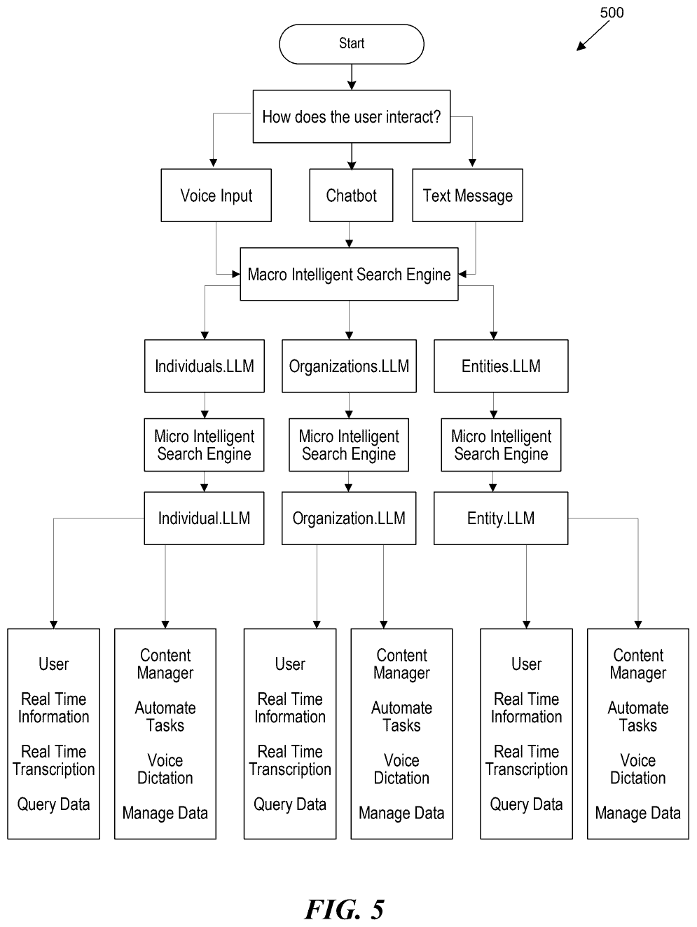

FIG. 5 illustrates a flowchart 500 of a method that can be performed to manage customized models, in accordance with one or more embodiments of this disclosure. For example, as described herein, a user may input their query and interact with the platform using voice input, which enables users to interact with the customized model management system 110 using spoken commands, enhancing accessibility and usability for both real-time and static data queries. In some embodiments, alternatively or additionally, a user interacts through a chatbot, and/or through text messaging. In such embodiments, the spoken or written communications are converted into text for further processing and analysis, contributing to the hybrid data approach.

In some embodiments, the query is input into the macro intelligent search engine alongside information accessed (e.g., in real-time) which utilizes a proprietary algorithm to process user queries and retrieve relevant information from both real-time and static data sources. The last row of the flowchart illustrates the continuous interaction loop between the user and the customized model management system 110. For example, the “user” may indicate ongoing queries and feedback; “real-time transcription” shows the processing of voice inputs; and “query data” represents the information being processed and refined. In some embodiments, this loop can ensure that the customized model management system 110 adapts and improves over time, providing accurate and relevant responses. Dynamic machine learning for prompt engineering plays a crucial role here by adapting to user interactions and optimizing the prompts for better accuracy. Such dynamic prompt engineering, allows the present technology to create a curriculum engine for customized model management system 110 and for each customized LLM associated therewith that evolves without the need for manual fine-tuning.

In some embodiments, the content manager oversees the creation, organization, and maintenance of the data and information within the LLMs. They ensure that the content is accurate, up-to-date, and relevant, facilitating efficient search and retrieval by the intelligent search engines. In some embodiments, the content manager can also work with dynamic machine learning models to continuously improve the prompt engineering process. For example, as described herein, custom LLM developers may input detailed information during the creation phase, such as location data (address, state, zip code) for real estate LLMs or specific expertise for subject matter experts. This structured information may in turn help the intelligent search engine accurately match and respond to user queries. In some embodiments, the structured information includes tags, or text strings, or parameters and fields that can be stored with the custom LLM (e.g., in the same file, or in a file corresponding to the LLM).

In one example, a user may provide a user input in the form of a verbal command “Star Coffee.” The phone's microphone may capture the audio input and perform speech-to-text conversion, e.g., through use of an ASR system that may convert the audio input into text: “Star Coffee.” This text may then be processed by the system. The phone's GPS module may also provide the user's current location coordinates (e.g., Latitude: 34.0522, Longitude: −118.2437).

In some embodiments, Real-Time DEtection TRansformer (RT-DETR) is used to analyze visual inputs from the phone's camera. If the user also takes a picture of the coffee shop, RT-DETR can quickly identify the shop in real-time based on the image. The model is capable of real-time object detection, ensuring that visual identification is fast and accurate.

In some embodiments, an NLP algorithm analyzes the text input “Star Coffee” and the GPS coordinates to understand the query's context and intent. The system checks if there is a known entity “Star Coffee” near the provided GPS coordinates. The macro intelligent search engine then uses the processed text and GPS data to identify relevant categories of LLMs (e.g., coffee shops) within the proximity of the user's location. In some embodiments, the algorithm assigns numerical values (e.g., scores) based on relevance and proximity. For instance, “Star Coffee” might score high if it matches closely with known entities in the area.

In some embodiments, the micro intelligent search engine is used to fine-tune the search within the identified category. For example, it may look for a specific match for “Star Coffee” and refine the query using dynamic machine learning prompt engineering. This process may involve algorithms that analyze historical data, user preferences, and context to improve the accuracy of the search results. The system may pull up (e.g., access) the specific address of “Star Coffee” (e.g., “123 Main St, Los Angeles, CA”). The system may query the user, “Is this the coffee shop you are referring to?” and display the address and any associated image.

In some embodiments, the user's responses is categorized and scored. For example, a positive response such as “yes” may be assigned a high numerical value to reinforce the accurate answer whereas a negative response, such as “no,” with certain trigger words (e.g., expletives) may be assigned a low numerical value, indicating the system needs to improve. In some embodiments, the user provides no response and the system may assign a neutral value, indicating no change in accuracy assessment.

According to some embodiments, if the user's query is outside the median or the system cannot confidently resolve it, the query is sent to a subject matter expert (SME). The SME can review and resolve the issue (e.g., by updating the query). Once the issue is resolved, the interaction is documented for future reference and to improve the LLM. These interactions and assigned values are collected and stored. This data helps to continuously refine and improve the accuracy and efficiency of the LLM. In some embodiments, detecting that the user's query is outside the median or that the system cannot confidently resolve it is part of the dynamic prompt engineering process.

In some embodiments, the system queries the customized LLM for “Star Coffee” using its unique URL: “starcoffee.LLM.” The LLM contains detailed information about “Star Coffee,” such as menu items, hours of operation, and customer reviews. In such embodiments, the system refines the prompt based on user interaction and feedback. For example, if the user often asks for menu items, the system learns to prioritize showing the menu first. The algorithm continuously updates to enhance the relevance of the responses.

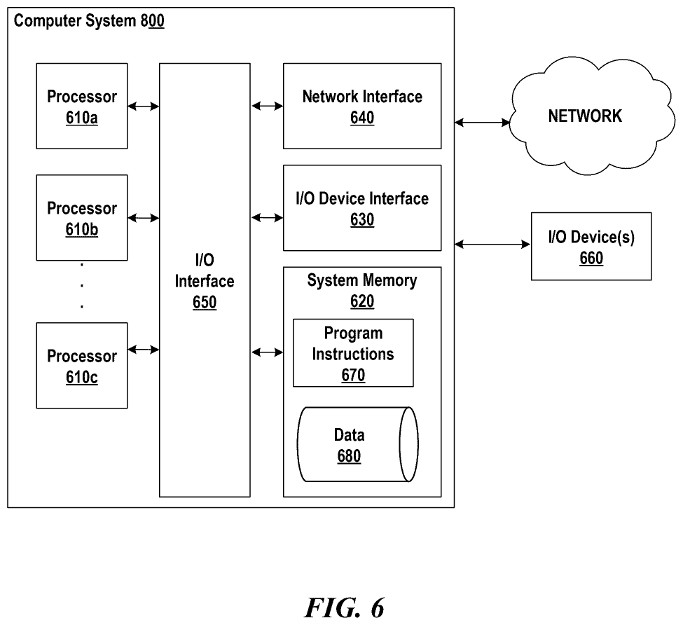

FIG. 6 shows an example computing system that may be used in accordance with some embodiments of this disclosure. In some instances, computer system 600 is referred to as a computing system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computer system 600. Further, processes and modules described herein may be executed by one or more processing systems similar to that of computer system 600.

Computer system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computer system 600. A processor may execute code (e.g., processor firmware, a protocol stack, a database management system, an operating system, or a combination thereof) that creates an execution environment for program instructions.

A processor may include a programmable processor. A processor may include general or special purpose microprocessors. A processor may receive instructions and data from a memory (e.g., system memory 620). Computer system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computer system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the internet, a LAN, a WAN, a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600 or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

As described herein, methods and techniques described herein can be adapted and utilized in various other fields and applications beyond its primary use case. For example, the system can be employed to assist healthcare professionals in accessing patient records, providing medical advice, or facilitating remote consultations. The technology can support personalized learning experiences, offering students access to educational resources, tutoring services, and interactive learning materials. Businesses can deploy the system to enhance customer support processes, automating responses to common inquiries, and providing timely assistance through chatbot interfaces. Law firms can utilize the system to conduct legal research, draft documents, and provide guidance on legal matters, streamlining various aspects of legal practice. Financial institutions can leverage the technology for real-time data analysis, risk assessment, and investment decision-making, improving overall operational efficiency and performance. The system can be integrated into manufacturing processes to optimize production schedules, monitor equipment performance, and identify areas for process improvement. Overall, the versatility and adaptability of the techniques enable its application across diverse industries and use cases, providing valuable solutions and insights tailored to specific needs and requirements.

It should be appreciated that the components or elements of techniques described herein can be interchanged or reconfigured in various ways to achieve an identical or similar function. For example, different algorithms can be employed within either of the intelligent search engines to process user queries, while alternative data transcription methods can be implemented to convert spoken or written communications into text. Similarly, the user interface can be redesigned to accommodate different interaction modalities, such as touch-based interfaces or gesture controls, without fundamentally altering the underlying functionality of the system. Additionally, the integration with external systems or databases can be adjusted to incorporate different data sources or communication protocols, providing flexibility in how information is accessed and utilized. Overall, these permutations and configurations allow for adaptability and customization while maintaining the core functionality of the invention.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, from a user device, a query and context metadata associated with the query, wherein context metadata is indicative of one or more circumstances locally detected by the user device as the query is received;
accessing, from a remote server, a plurality of customized domain specific artificial intelligence (AI) models, wherein the customized domain specific AI models are indexed with web addresses by categorical function indicia;
identifying, via a first stage of a search engine, a first category of the categorical function indicia of the customized domain specific AI models based on the query and the context metadata associated with the query;
identifying, via a second stage of the search engine, a particular customized domain specific AI model of the first category based on the query and the context metadata associated with the query;
in response to identifying the particular customized domain specific AI model, automatically transmitting the query to the particular customized domain specific AI model;
receiving, from the particular customized domain specific AI model, a response to the query; and
causing a display of the response on the user device.

2. The method of claim 1, wherein the query comprises one or more of:
a natural language voice input;
a natural language text message;
an image;
a document; or
a scanned QR code.

3. The method of claim 1, wherein the context metadata associated with the query comprises one or more of:
a location of the user device;
a location context associated with the location of the user device;
a timestamp of the query; and
information about the user device.

4. The method of claim 1, further comprising:
receiving the query at the user device; and
in response to receiving the query at the user device, extracting, via the user device, the context metadata associated with the query.

5. The method of claim 1, further comprising:
identifying, via the first stage of the search engine, the first category of the categorical function indicia by:
parsing the query via a natural language processing model of the first stage of the search engine;
analyzing, via a contextual analysis function of the first stage of the search engine, the parsed query to determine a context of the query;
generating, via the contextual analysis function of the first stage of the search engine, an updated query based on the context of the query;
generating, via a machine learning model of the first stage of the search engine that is configured to generate a ranked list of relevant results based on the updated query, the ranked list of relevant results; and
compare, via a domain look up function of the first stage of the search engine, the ranked list of relevant results to the categorical function indicia.

6. The method of claim 1, further comprising:
in response to a failure to identify a customized domain specific AI model for the query:
generating a custom AI model based on the query;
establishing a domain for the custom AI model; and
transmitting a notification to an entity associated with the custom AI model.

7. The method of claim 1, further comprising:
transmitting, from the first stage of the search engine to the second stage of the search engine, data identifying the first category or a pointer to the data identifying the first category stored in a memory; and
identifying, via the second stage of the search engine, the particular customized domain specific AI model of the first category based on the query, wherein the particular customized domain specific AI model is associated with the data.

8. The method of claim 1, wherein the categorical function indicia are associated with customized domain specific models for individuals, customized domain specific models for organizations, or customized domain specific models for entities.

9. The method of claim 1, further comprising:
identifying that the response to the query does not achieve an intent of a user, wherein the user input the query to the user device;
causing the user device to display a request for a second query from the user;
receiving, from the user device, the second query; and
updating the query and the context metadata associated with the query based on the second query.

10. The method of claim 1, wherein the query comprises a scanned QR code associated with the particular customized domain specific AI model, and wherein the scanned QR code includes a pre-generated search query, further comprising:
upon receiving the scanned QR code, automatically identifying the particular customized domain specific AI model;
in response to identifying the particular customized domain specific AI model, automatically transmitting the pre-generated search query to the particular customized domain specific AI model;
receiving, from the particular customized domain specific AI model, the response to the pre-generated search query; and
causing the display of the response on the user device.

11. A system comprising:
a user device configured to:
receive a query and context metadata associated with the query, wherein context metadata is indicative of one or more circumstances locally detected by the user device as the query is received; and
a search engine configured to:
receive, from the user device, the query and the context metadata;
access, from a remote server, a plurality of customized domain specific artificial intelligence (AI) models, wherein the customized domain specific AI models are indexed with web addresses by categorical function indicia;
identify a first category of the categorical function indicia of the customized domain specific AI models based on the query and the context metadata associated with the query;
identify a particular customized domain specific AI model of the first category based on the query and the context metadata associated with the query;
in response to identifying the particular customized domain specific AI model, automatically transmit the query to the particular customized domain specific AI model;
receive, from the particular customized domain specific AI model, a response to the query; and
cause a display of the response on the user device.

12. The system of claim 11, wherein the query comprises one or more of:
a natural language voice input;
a natural language text message;
an image;
a document; or
a scanned QR code.

13. The system of claim 11, wherein the context metadata associated with the query comprises one or more of:
a location of the user device;
a location context associated with the location of the user device;
a timestamp of the query; and
information about the user device.

14. The system of claim 11, wherein the user device is further configured to:
in response to receiving the query at the user device, extract the context metadata associated with the query.

15. The system of claim 11, wherein the search engine is further configured to:
identify the first category of the categorical function indicia by:
parsing the query via a natural language processing model of the search engine;
analyzing, via a contextual analysis function of the search engine, the parsed query to determine a context of the query;
generating, via the contextual analysis function of the search engine, an updated query based on the context of the query;
generating, via a machine learning model of the search engine that is configured to generate a ranked list of relevant results based on the updated query, the ranked list of relevant results; and
comparing, via a domain look up function of the search engine, the ranked list of relevant results to the categorical function indicia.

16. The system of claim 11, wherein, in response to a failure to identify a customized domain specific AI model for the query, the search engine is further configured to:
generate a custom AI model based on the query;
establish a domain for the custom AI model; and
transmit a notification to an entity associated with the custom AI model.

17. The system of claim 11, wherein the categorical function indicia are associated with customized domain specific models for individuals, customized domain specific models for organizations, or customized domain specific models for entities.

18. The system of claim 11, wherein the search engine is further configured to:
identify that the response to the query does not achieve an intent of a user, wherein the user input the query to the user device;
cause the user device to display a request for a second query from the user;
receive, from the user device, the second query; and
update the query and the context metadata associated with the query based on the second query.

19. The system of claim 11, wherein the query comprises a scanned QR code associated with the particular customized domain specific AI model, wherein the scanned QR code includes a pre-generated search query, and wherein the search engine is further configured to:
upon receiving the scanned QR code, automatically identify the particular customized domain specific AI model;
in response to identifying the particular customized domain specific AI model, automatically transmit the pre-generated search query to the particular customized domain specific AI model;
receive, from the particular customized domain specific AI model, the response to the pre-generated search query; and
cause the display of the response on the user device.

20. A tiered search engine comprising:
a communication module configured to receive, from a user device, a query and a context metadata, wherein context metadata is indicative of one or more circumstances locally detected by the user device as the query is received;
a first tier of the tiered search engine configured to:
access, from a remote server, a plurality of customized domain specific artificial intelligence (AI) models, wherein the customized domain specific AI models are indexed with web addresses by categorical function indicia;
identify a first category of the categorical function indicia of the customized domain specific AI models based on the query and the context metadata associated with the query; and
a second tier of the tiered search engine configured to:
identify a particular customized domain specific AI model of the first category based on the query and the context metadata associated with the query;
in response to identifying the particular customized domain specific AI model, automatically transmit the query to the particular customized domain specific AI model;
receive, from the particular customized domain specific AI model, a response to the query; and
cause the communication module to display the response to the query on the user device.

21. The tiered search engine of claim 20, wherein the query comprises one or more of:
a natural language voice input;
a natural language text message;
an image;
a document; or
a scanned QR code.

22. The tiered search engine of claim 20, wherein the context metadata associated with the query comprises one or more of:
a location of the user device;
a location context associated with the location of the user device;
a timestamp of the query; and
information about the user device.

23. The tiered search engine of claim 20, further comprising:
the first tier of the tiered search engine further configured to:
identify that the response to the query does not achieve an intent of a user, wherein user input the query to the user device;
cause the user device to display a request for a second query from the user;
receive, from the user device, the second query; and
update the query and the context metadata associated with the query based on the second query.

24. The tiered search engine of claim 20, wherein the query comprises a scanned QR code associated with the particular customized domain specific AI model, wherein the scanned QR code includes a pre-generated search query, further comprising:
the second tier of the tiered search engine further configured to:
upon receiving the scanned QR code, automatically identify the particular customized domain specific AI model;
in response to identifying the particular customized domain specific AI model, automatically transmit the pre-generated search query to the particular customized domain specific AI model;
receive, from the particular customized domain specific AI model, the response to the pre-generated search query; and
cause the display of the response on the user device.
